(19) United States
(12) Patent Application Publication
(10) Pub. No.: US 2024/0333195 A1
(43) Pub. Date: Oct. 3, 2024

(54) Greenhouse integrated with PVT panel based power generation and energy storage system and vacuum solar collector based thermal power generation system and hydrogen generation system

(71) Applicant: Yonghua Wang, Klamath Falls, OR (US)

(72) Inventor: Yonghua Wang, Klamath Falls, OR (US)

(21) Appl. No.: 18/445,092

(22) Filed: Apr. 1, 2023

(51) Int. Cl. H02S 10/10; A01G 9/24; F24D 18/00; H02S 20/26; H02S 40/44

(52) U.S. Cl. CPC H02S 10/10; A01G 9/243; F24D 18/00; H02S 20/26; H02S 40/44

(57) ABSTRACT

A greenhouse solar power generation system comprises a south facing greenhouse structure, a north facing wall as an active hybrid photovoltaic and solar thermal panel based electricity and heat cogeneration and storage system, a group of vacuum tube based steam generators, a hydrogen generation storage and power generation system, and thermal power generation system. A hybrid photovoltaic and solar thermal panel array attached to the north facing wall cogenerates electricity and thermal energy. The cogenerated thermal energy is raised in temperature by the vacuum tube based steam generators for thermal power generation; and the cogenerated electricity is used to generate hydrogen. The greenhouse solar power generation system generates hydrogen and agriculture products simultaneously.

### TECHNICAL FIELD

The present disclosure relates generally to solar powered greenhouse, more specifically, to a greenhouse integrated with a hybrid photovoltaic and solar thermal panel based power generation and energy storage system, a vacuum tube steam generation system, a thermal power generation system, and a hydrogen generation system.

### BACKGROUND

As the wide-spread adoption of photovoltaic technology, the conflict of land use between agriculture and solar power generation becomes prominent. Agrivoltaics provides an unparallel solution in addressing the challenge in land use. Photovoltaic panel arrays and agricultural crops co-present on the same land to synergistically leverage each other. Photovoltaic panel arrays partially block some of solar radiation and create a relatively cool environment for some crops such as grapes, which prefer a reduced solar radiation and a cool environment, and the growth of agricultural crops reduces the ground absorption of solar radiation and consequently reduces the working temperature of photovoltaic panels. The combination of electricity generation and agricultural production significantly increase the revenue of agricultural lands and greatly benefit farmer communities. The even more attractive version of agrivoltaics is the combination of green house and hybrid photovoltaic and solar thermal panel arrays, wherein, the hybrid photovoltaic and solar thermal (PVT) panel arrays cogenerate electricity and thermal energy; the co-generated electricity is directly delivered to power grid and the cogenerated thermal energy is used to heat the green house. In conjunction with solar vacuum tube steam generator and thermal storage, the cogenerated thermal energy from the PVT panels can be elevated in temperature and stored in the thermal storage. By incorporating thermal power generation system, the stored thermal energy can be extracted to generate electric power. The photovoltaic generated power and thermal generated power can be coordinated to realize stabilized power generation. The residue of thermal energy after thermal power generation can be used to heat the greenhouse. With the PVT and green house based agrivoltaics, the agricultural lands can be turned into power generation stations to support fully renewable energy powered power grid systems. The agrivoltaics generated electricity can also be used to electrolyze water to generate hydrogen in remote area without power grid systems for charging hydrogen based vehicles such as hydrogen internal combustion engine vehicle. Integrating PVT array, thermal storage, vacuum tube steam generator, thermal power generation system, and hydrogen generation system into greenhouse system in a synergistically manner presents a grand challenge in front of the renewable energy researchers and engineers.

U.S. Pat. No. 9,554,523 B2 granted to Carroll et al (Carroll) discloses a passive green house system comprising an enclosed glass or plastic green house and thermal energy storage made of thermal mass. In operation, the thermal mass is expected to absorb and store heat during daytime and release heat during nighttime. However, the heat transfer inside the thermal mass is not under control. The passive charging and discharging processes of the thermal mass are not effective in terms of heating the interior environment of the green house during nighttime.

CA 2738036 C granted Myntti et al (Myntti) discloses a greenhouse for year-round usage. Myntti's greenhouse comprises photovoltaic panels integrated onto the roof of the greenhouse. The photovoltaic panels generate electricity but block some sunlight preventing it penetrating into the greenhouse. Myntti's greenhouse doesn't have energy storage system.

U.S. Pat. No. 8,418,401 B2 granted to Chuang et al (Chuang) discloses a photovoltaic greenhouse structure with thin film photovoltaic modules integrated into the roof of the greenhouse. Chuang's greenhouse selectively filters out some of the unnecessary components of solar spectrum for growth of plants to generate electric power and allow the useful components of solar spectrum relative to the growth of plants to penetrate into the greenhouse. The thin film photovoltaic modules integrated into Chuang's greenhouse are used to only convert partial solar spectrum and therefore has lower conversion efficiency relative to full spectrum photovoltaic modules. Chuang's greenhouse has no energy storage either.

U.S. Pat. No. 9,554,523 B2 granted to Carroll (Carroll) discloses a passive solar greenhouse with thermal energy storage integrated. Carroll's passive energy storage can balance the temperature fluctuation inside of the greenhouse. However the charging and discharging of the thermal energy storage is not under control. The passive heat transfer between the environment of the greenhouse and the thermal energy storage is not efficient in terms of storing energy and releasing heat for heating the greenhouse.

The instant application discloses a active solar greenhouse integrated with thermal energy storage, hybrid photovoltaic and solar thermal panels, vacuum tube steam generator, and electrochemical electrolysis hydrogen generation system to cogenerate electricity and thermal energy, store the cogenerated thermal energy, raise the temperature of the stored thermal energy and generate steam, use the steam to regenerate electric power by using thermal power generation system, and use the photovoltaic generated electricity and thermal power generation system generated electricity to electrolyze water to produce hydrogen. After the thermal power generation, the residue heat is used to heat up the greenhouse. Through this configuration, the instant invention aims to turn this active solar-greenhouse into a stabilized solar fuel generation station and electric power generation station operating without competing with agriculture for land use.

### SUMMARY

According to the present invention, an active solar greenhouse is configured with a single slope greenhouse structure, a north wall made of a hybrid photovoltaic and solar thermal panel based electricity and thermal energy cogeneration system with thermal energy storage, a vacuum tube based steam generation system installed on the top of the north wall, a thermal power generation system, and a electrochemically electrolysis system for hydrogen generation from water. When in operation, a portion of the incident sunlight penetrating through the greenhouse structure and arriving at the hybrid photovoltaic and solar thermal arrays attached to the north wall made of thermal energy storage tanks is converted into electricity and thermal energy; the electricity is directly used to generate hydrogen through the electrochemically electrolysis system; the thermal energy is elevated in temperature through the vacuum tube based steam generation system and stored in the storage tanks; the stored thermal energy is extracted out to generate electricity during night or cloudy days through the thermal power generation system; the thermal generated electricity is used to generate hydrogen through the electrochemically electrolysis system; the residue heat after thermal power generation is used to heat up the greenhouse structure. The entire system of the instant invention not only addresses the issue of the conflict between solar power generation and agriculture production in land use, but also addresses the issue of utility scale energy storage of renewable energy through active thermo-electric energy storage. The integration of the hybrid photovoltaic and solar thermal array into the greenhouse system not only enables electrical and thermal cogeneration, but also dramatically increases the total conversion efficiency to over 70%.

Further aspects and advantages of the present invention will become apparent upon consideration of the following description thereof, reference being made of the following drawings.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is the cross section view of the greenhouse system integrated with hybrid photovoltaic and solar thermal panel based solar power generation and thermal energy storage system, vacuum solar collector based thermal power generation system, and hydrogen generation system.

FIG. 2 is the over view of the greenhouse system integrated with hybrid photovoltaic and solar thermal panel based solar power generation and thermal energy storage system, vacuum solar collector based thermal power generation system, and hydrogen generation system.

FIG. 3 is the hybrid photovoltaic and solar thermal panel based solar power generation and thermal energy storage system as the main component of the north facing wall of the greenhouse system of the present invention.

FIG. 4 is the schematic diagram indicting the connections between the components of the greenhouse system of the present invention.

### DETAILED DESCRIPTION

Reference will now be made in detail to the present exemplary embodiments, examples of which are illustrated in the accompanying drawings. Wherever possible, the same reference numbers will be used throughout the drawings to refer to the same or like parts.

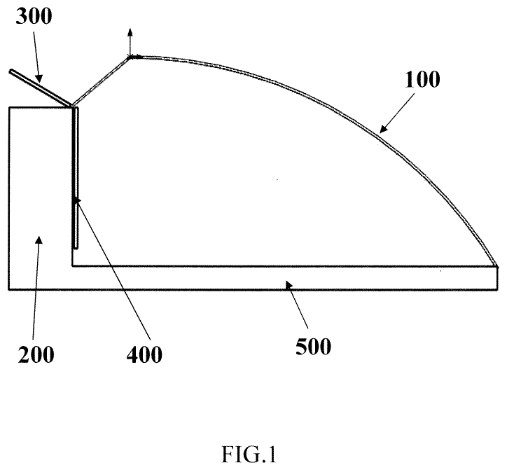

Referring to FIG. 1, the greenhouse system comprises: 1) a Chinese style green house with a green house structure 100 and a north facing wall 200; 2) a hybrid photovoltaic and solar thermal panel array 400; 3) a vacuum tube based solar steam generator array 300; 4) a hydrogen generation system; 5) a thermal power generation system; 6) a ground floor 500 containing a floor heating system; 7) a heat pump system; 8) a control system. Wherein, a portion of the incident sunlight is directly absorbed by the greenhouse structure directly, the other portion of the incident sunlight is absorbed by the hybrid photovoltaic and solar thermal arrays attached to the north facing wall to cogenerate electricity and thermal energy; the cogenerated thermal energy is stored inside of the north facing wall; the cogenerated electricity is used to electrochemically generate hydrogen and further generate electric power through fuel cells or hydrogen internal combustion engine; the stored thermal energy is extracted out to generate steam for thermal power generation through the vacuum tube based steam generators; the heat pump system is employed to provide auxiliary heating during cloudy days; the control system is used to coordinate each of the component of the system.

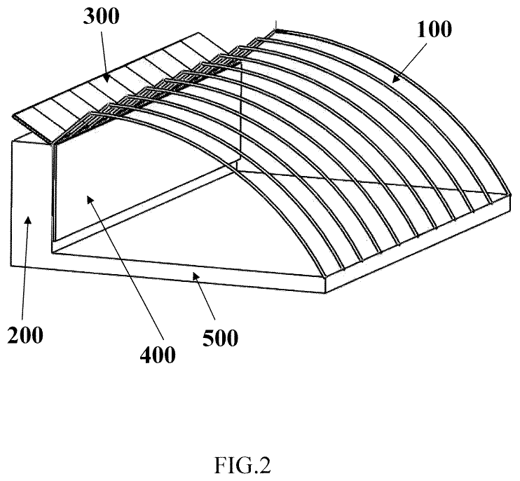

Referring to FIG. 2, the vacuum tube based steam generators 300 are installed on the top of the north facing wall 200, which contains insulated low temperature thermal energy storage tanks, high pressure and high temperature steam storage tanks, and hydrogen storage tanks; the hybrid photovoltaic and solar thermal panel array 400 is attached to the north facing wall 200; the ground floor of the green house system contains a floor heating system for circulating the stored heat from the low temperature thermal energy storage tanks.

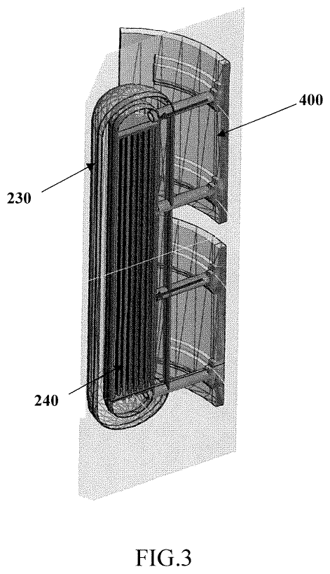

Referring to FIG. 3, the hybrid photovoltaic and solar thermal panel based electricity and thermal energy cogeneration system comprises the hybrid photovoltaic and solar thermal panel array 400, and the low temperature storage tank 210 and heat exchanger 220. When in operation, the cogenerated thermal energy is extracted out from the backside of the hybrid photovoltaic and solar thermal panel array 400 and stored in the storage tank 210; the photovoltaic part of the hybrid photovoltaic and solar thermal panel array 400 is cooled down; the stored thermal energy is circulated into the greenhouse structure 100 to heat the greenhouse through the heat exchanger 220.

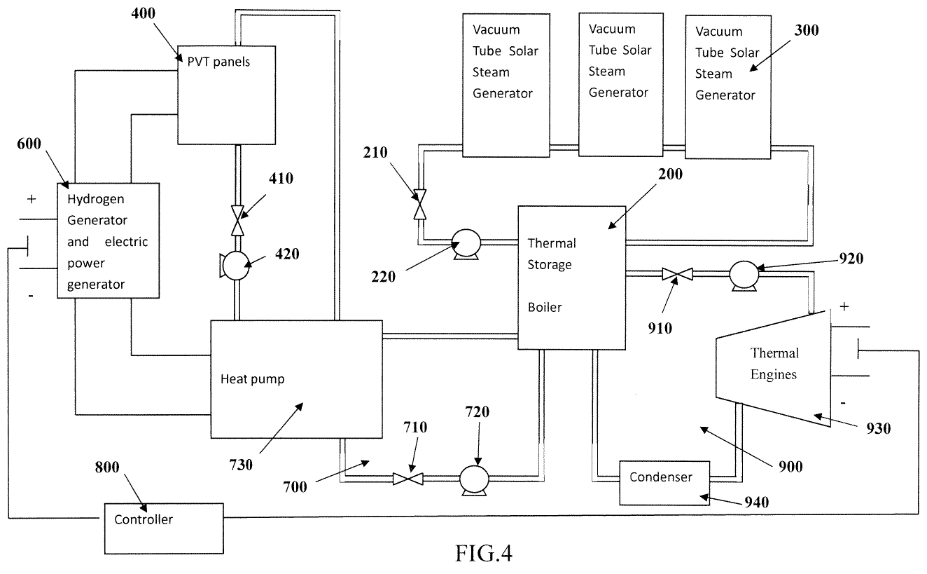

Referring to FIG. 4, all components of the greenhouse system of the present invention are configured in such a way that the hybrid photovoltaic and solar thermal array 400 is electrically connected to the hydrogen generation and storage and electric power generation system 600 containing electrochemically electrolysis system, hydrogen tanks, and fuel cells or hydrogen internal combustion engine based electric power generation system; the hydrogen power generation system is electrically connected to the heat pump 730 to provide electric power; the hybrid photovoltaic and solar thermal panel array 400 is connected to heat pump through pump 420 and valve 410 to raise temperature of the cogenerated thermal energy from the hybrid photovoltaic and solar thermal panel array 400; the heat pump is connected to the thermal storage system 200 containing low temperature storage tanks as condenser 940 of the thermal power generation system 900 and high temperature storage tanks as the boiler of the thermal power generation system 900; the low temperature storage tanks are connected to the high temperature thermal storage tanks through the valve 210, pump 220, and the vacuum tube based steam generators 300; the thermal storage 200 is connected to the thermal engine 930 through valve 910 and pump 920; the control system 800 is electrically connected to each of the components of the greenhouse system to coordinate the operation of each of the components, and especially to coordinate the electric power generation of the hydrogen power generation system 600 and the thermal power generation system 900 to realize the stabilized power generation. Wherein, the hybrid photovoltaic and solar thermal panel array cogenerate electricity and thermal energy, the electricity is used to generate hydrogen, and the thermal energy is used to store energy and generate electric power, and the residue heat of the thermal power generation system is used to heat up the greenhouse; the vacuum tube based steam generators are employed to raise the temperature of the cogenerated thermal energy from the hybrid photovoltaic and solar thermal panel array.

From the description above, a number of advantages of the wall module become evident. The hybrid photovoltaic and solar thermal panel array not only generates both electrical energy and thermal energy to dramatically increase the total conversion efficiency of solar system, but also stores the generated thermal energy; this enables the whole greenhouse to be a large scale power generation and storage system. The greenhouse system produces both hydrogen and electric power. The incorporation of the hybrid photovoltaic and solar thermal panel array based solar power generation system into the north facing wall of the Chinese style greenhouse turns it from a passive greenhouse into a active greenhouse so that the stored heat can be distributed into the greenhouse in a controlled manner. The combination of the hybrid photovoltaic and solar thermal panel array and the vacuum tube based steam generators dramatically increases the efficiency of the thermal power generation system and significantly reduce its cost. The instant invention not only addresses the issue of the conflict between solar power generation and agricultural production in land use, but also addresses the issue of utility scale energy storage.

I claim:

1. A greenhouse solar power generation system comprises: 1) a greenhouse structure; 2) a hybrid photovoltaic and solar thermal panel array; 3) a hydrogen storage and thermal storage system as the north wall of the greenhouse; 4) a vacuum tube based steam generation system; 5) a floor heating system for greenhouse; 6) a hydrogen generation and a electric power generation system; 7) a thermal power generation system; 8) a heat pump system; 9) a control system;
wherein, the greenhouse structure combines with the north wall to form a Chinese style greenhouse; the hybrid photovoltaic and solar thermal panel array is attached to the north wall and connected to the thermal storage system to form a electricity and thermal energy cogeneration and storage system; the vacuum tube based steam generation system is installed on the top of the north wall and connected to the cogeneration and storage system to raise temperature of the cogenerated thermal energy; the floor heating system is connected to the thermal storage of the north wall to heat up the green house; the hybrid photovoltaic and solar thermal panel array is connected to the a hydrogen generation and a electric power generation system to generate hydrogen and generate electric power from hydrogen; the thermal power generation system is connected to the thermal storage system to generate electric power; the heat pump system connects the low temperature thermal storage and high temperature thermal storage; the heat pump is connected to the hydrogen electric power generation system electrically; the control system is electrically connected to each of the components to coordinate the operation of each of the components.

2. The greenhouse solar power generation system of claim 1, wherein, the hydrogen storage and thermal storage system as the north wall of the greenhouse comprises a group of low temperature thermal storage tanks, a group of high pressure and high temperature steam thermal storage tanks, and a group of hydrogen storage tanks.

3. The group of low temperature thermal storage tanks and the group of high pressure and high temperature steam thermal storage tanks of claim 2 as condenser and evaporator are connected through the thermal power generation engine to form thermal power generation system.

4. The greenhouse solar power generation system of claim 1, wherein, the hydrogen generation and a electric power generation system comprises a electrochemical electrolysis system, a group of hydrogen storage tanks, and a fuel cell or hydrogen internal combustion engine based power generation system.

5. The hydrogen generation and a electric power generation system of claim 4, wherein, the electrochemical electrolysis system is connected to the group of hydrogen storage tanks to charge the tanks; and the fuel cell or hydrogen internal combustion engine based power generation system is connected to the group of hydrogen storage tanks to discharge the tanks.

6. The greenhouse solar power generation system of claim 1, wherein, the hybrid photovoltaic and solar thermal panel array is connected with the low temperature thermal storage tanks to form electricity and thermal energy cogeneration and energy storage system.
